(19) United States
(12) Patent Application Publication
(10) Pub. No.: US 2019/0191083 A1
(43) Pub. Date: Jun. 20, 2019

(54) DEVICE AND SYSTEM FOR CAPTURING DATA FROM AN ENVIRONMENT AND PROVIDING CUSTOM INTERACTIONS THEREWITH

(71) Applicant: SERGEI GORLOFF, VENETIA, PA (US)

(72) Inventor: SERGEI GORLOFF, VENETIA, PA (US)

(21) Appl. No.: 16/222,539

(22) Filed: Dec. 17, 2018

Related U.S. Application Data
(60) Provisional application No. 62/599,413, filed on Dec. 15, 2017.

(51) Int. Cl. H04N 5/232; H04N 5/247; H04N 5/225

(52) U.S. Cl. CPC H04N 5/23238; H04N 5/247; H04N 13/204; H04N 5/2252; H04N 5/2253

(57) ABSTRACT

A device for capturing data includes a base; a frame extending from the base, the frame disposed about a central axis; and a plurality of video cameras coupled to the frame facing outward from the central axis, wherein the plurality of video cameras are positioned so as to capture a continuous 360° view outward around the central axis.

### CROSS-REFERENCE TO RELATED APPLICATIONS

This patent application claims the priority benefit under 35 U.S.C. § 119(e) of U.S. Provisional Application No. 62/599,413 filed on Dec. 15, 2017, the contents of which are herein incorporated by reference.

### BACKGROUND

### 1. Field

The disclosed concepts relate to devices for capturing data, and to devices which allow for interactions with persons. The disclosed concepts further relate to arrangements and method for using such devices.

### 2. Description of the Related Art

In convenience stores and other places where business transactions commonly take place, video cameras are typically placed on the perimeter of the area being surveilled facing inward, toward the cashier(s), customer(s), point of sale, and other areas of interest. Such arrangement generally involves complex installation procedures of multiple video cameras and does not guaranty unobstructed views of objects of interest, e.g., faces of customers, counter surfaces, cash drawer(s), etc. Accordingly, video obtained from such arrangements often times is not useful for identifying people or objects from particular events of interest (e.g., transactions, incidents, etc.).

As technology has advanced, the use of facial recognition has become more prominent as a tool for identifying people. However, an unobstructed view of human faces is critical for accurate facial recognition functionality, a view typically not provided by such conventional surveillance systems.

Another approach to surveilling a space that has been employed is the use of cameras secured to the ceiling above the space and positioned away from the walls of the space. Such cameras are generally either positioned at an elevation just below the ceiling, or in spaces with higher ceilings (e.g., warehouses, casinos, etc.), may be positioned a distance below the ceiling at the end of a rod or similar structure. In either case, such cameras are typically hidden behind a tinted or reflective dome, so as to generally hide the camera and thus generally disguise the direction in which the camera is facing. While such camera positionings provide for improved views of areas as compared to cameras solely disposed about the perimeter of a given area, the elevation of such cameras (i.e., well above the heads of people in the space) still leaves a lot to be desired for the views they provide in most instances, and in most cases also fail to provide views which may be utilized by facial recognition systems.

### SUMMARY

Embodiments of the disclosed concept provide devices which can capture video from better locations and angles than conventional arrangements. Additionally, such devices can capture other types of data from the surrounding area and objects, and such devices can interact with the environment and humans by using human interface devices, various sensors and data capturing devices.

As one aspect of the disclosed concept, a device for capturing data comprises: a base; a frame extending from the base, the frame disposed about a central axis; and a plurality of video cameras coupled to the frame facing outward from the central axis, wherein the plurality of video cameras are positioned so as to capture a continuous 360° view outward around the central axis.

The plurality of cameras may comprise four cameras, each camera being disposed at a 90° degree angle with respect to each adjacent camera.

Each camera of the plurality of cameras may be disposed at the same elevation as the other cameras of the plurality of cameras.

Each camera of the plurality of cameras may be pivotably coupled to the frame.

Each camera may be pivotably coupled to the frame via a mount, wherein each camera is movable between a first position and a second position, the second position being further from the central axis than the first position.

When disposed in the first position, each camera of the plurality of cameras may be disposed generally parallel to the central axis, and wherein when disposed in the second position, each camera may be disposed at an angle with respect to the central axis.

The angle, in degrees, may be generally equal to (180−the field of view of the camera)/2.

Each camera of the plurality of cameras may be biased in the first position via a biasing mechanism.

The device may further comprise an enclosure having an enclosure base, wherein the enclosure may be structured to enclose the plurality of cameras, wherein the enclosure may be selectively coupleable to the base via the enclosure base, and wherein each camera of the plurality of cameras may be movable from the first position to the second position via an engagement between the enclosure base and the mount to which each camera is pivotally coupled to the frame as the enclosure base is moved toward the base generally along the central axis.

The enclosure base may be selectively coupleable to the base via a threaded engagement.

The enclosure may be of a generally spherical shape.

The enclosure may be formed as a unitary piece of material. The material may comprise acrylic.

The device may further comprise a number of three dimensional video and infrared capturing devices coupled to the frame.

The number of three dimensional video and infrared capturing devices may comprise: a first three dimensional video and infrared capturing device oriented in a first direction facing outward from the central axis; and a second three dimensional video and infrared capturing device oriented facing in a second direction, opposite the first direction, outward from the central axis.

The device may further comprise a voice recognition device coupled to the frame.

The device may further comprise a speaker coupled to the frame.

The device may further comprise one or more of: an indication light, a microphone, and/or an environmental sensor coupled to the frame.

As another aspect of the disclosed concept, an arrangement for capturing data related to a transaction comprises: a first area structured to receive a first party involved in the transaction; a second area structured to receive a second party involved in the transaction; and a device as previously described positioned generally between the parties at an elevation at an elevation generally at or below the face of at least one of the first or second party.

As yet a further aspect of the disclosed concept, a method of capturing data in a space defined by at least a floor and a number of walls comprises: positioning a device as previously described in the space at a location away from the number of walls, the device being supported by a structure extending from the floor of the space; and capturing data using the device.

These and other objects, features, and characteristics of the disclosed concepts, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed concepts.

### BRIEF DESCRIPTION OF THE DRAWINGS

FIG. 1 is an elevation view of an example device for capturing data shown positioned on an example base arrangement in accordance with an example embodiment of the disclosed concept;

FIG. 2 is an isometric view of the device and arrangement of FIG. 1, shown with portions cut away to show internal details;

FIG. 3 is an enlarged view of the device of FIG. 2, such as generally indicated in FIG. 2;

FIG. 4 is an elevation view of the device of FIGS. 1-3, shown with half of the spherical enclosure of the device cut away so as to show internal details of the device;

FIG. 5 is a top view of the device of FIGS. 1-4, shown with the top half of the spherical enclosure of the device cut away so as to show internal details of the device;

FIG. 6 is an elevation view of the device of FIGS. 1-5, shown with the spherical enclosure thereof uncoupled from the device showing portions of the device in a positioning different from that shown in FIGS. 2-5;

FIG. 7 is an elevation view similar to that of FIG. 1, but showing the relative positioning of the example device with example human beings interacting therewith;

FIG. 8 is a top view of the arrangement of FIG. 7, shown with the spherical enclosure of the example device removed to show an example of the positioning of internal structures of the device relative to the example humans;

FIG. 9 is an elevation view of the example device of FIGS. 1-8, positioned on another example base arrangement in accordance with another example embodiment of the disclosed concept, shown with an example human being interacting therewith;

FIG. 10 is an elevation view of the example device of FIGS. 1-9, positioned on another example base arrangement in accordance with yet another example embodiment of the disclosed concept, shown with an example human being interacting therewith; and

FIG. 11 is a flow chart showing a processing for enriching and utilizing data in accordance with an example embodiment of the disclosed concept.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are coupled directly in contact with each other (i.e., touching). As used herein, “fixedly coupled” or “fixed” means that two components are coupled so as to move as one while maintaining a constant orientation relative to each other.

As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, left, right, upper, lower, front, back, on top of, and derivatives thereof, relate to the orientation of the elements shown in the drawings and are not limiting upon the claims unless expressly recited therein. As employed herein, the term “and/or” shall mean one or both of the elements separated by such term. For example, “A and/or B” would mean any of: i) A, ii) B, or iii) A and B.

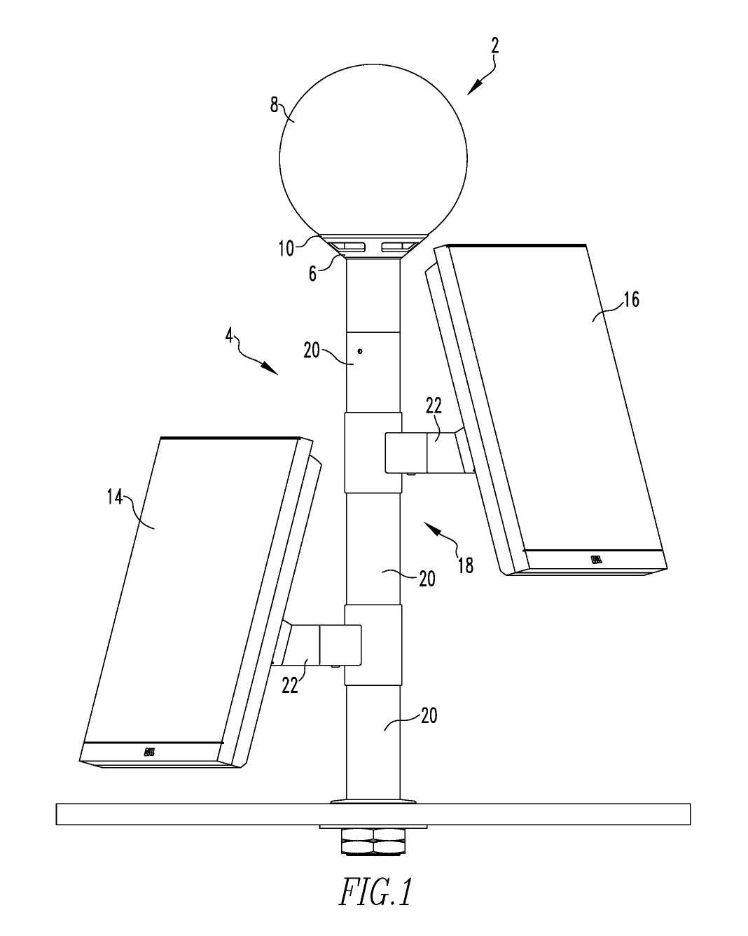

Referring to FIG. 1, an elevation view of an example device 2 for capturing data is shown positioned on an example base arrangement 4 in accordance with an example embodiment of the disclosed concept. Device 2 includes a base 6 which is selectively coupled (as will be discussed below) to base arrangement 4, and an enclosure 8 having an enclosure base 10 which is selectively coupled to base 6. In the illustrated example embodiment, enclosure base 10 is selectively coupled to base 6 via a threaded engagement between cooperating threaded portions of base 6 and enclosure base 10, it is to be appreciated, however, that other suitable coupling arrangements may be employed without varying from the scope of the disclosed concept. In the illustrated example embodiment, enclosure 8 is generally spherically-shaped and formed as an optically transparent, unitary piece of material (e.g., acrylic), which is coupled (e.g., via any adhesive or other suitable arrangement) to base 6 which is formed from a generally rigid material (e.g., hard plastic, aluminum, etc.). Enclosure 8 may be tinted or otherwise treated so as to obscure/hide the components housed therein. It is to be appreciated that enclosure 8 may be of a different shape and/or formed from other materials without varying from the scope of the disclosed concepts. Additionally, it is to be appreciated that device 2 may be utilized without enclosure 8 without varying from the scope of the disclosed concepts.

In the example shown in FIG. 1, base arrangement 4 includes a first touchscreen monitor 14 and a second touchscreen monitor 16, such as may be used in typical purchase transaction involving a cashier (not shown, e.g., using first monitor 14) and a customer (not shown, e.g., using second monitor 16). First and second touchscreen monitors 14 and 16 are mounted on a free-form expandable base 18 having replaceable vertical members 20 and arm members 22 which generally allow for the positioning of any of: device 2, first monitor 14, and second monitor 16, with respect to each other, or to the surrounding environment, to be readily adjusted. It is to be appreciated, however, that base arrangement 4 is provided for exemplary purposes only and is not intended to be limiting upon the scope of the disclosed concept as device 2 may be employed with various other base arrangements 4, some other examples of which are discussed below and illustrated in other figures.

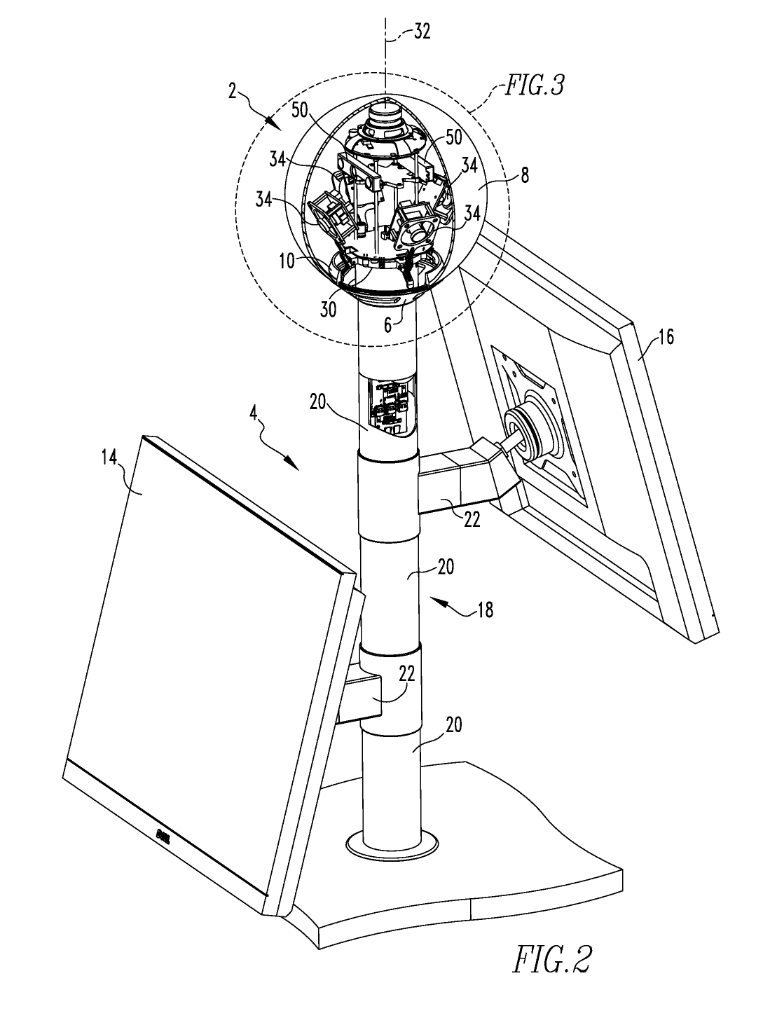

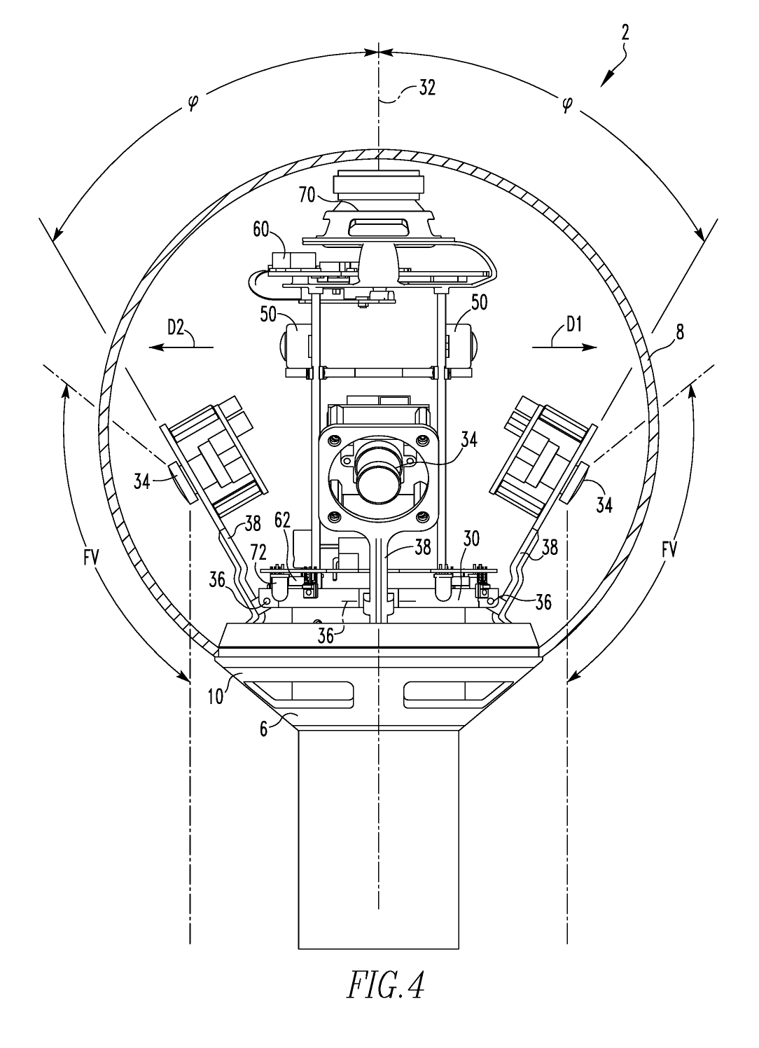

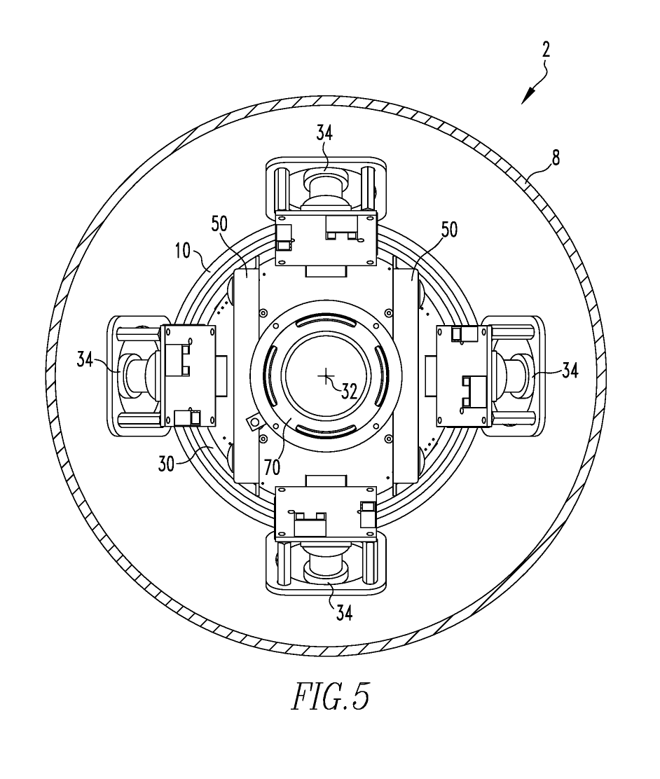

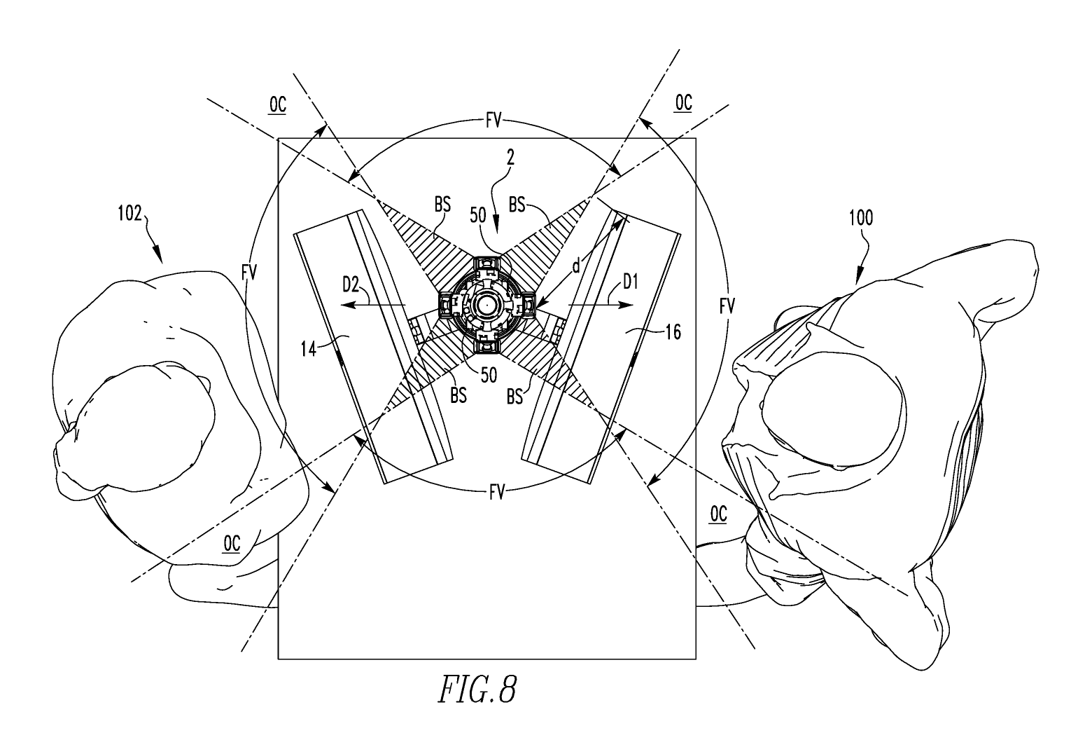

Referring now to FIGS. 2-5, various views of device 2 are shown with portions of enclosure 8 cut away to show internals details of device 2. Device 2 further includes: a frame 30 which extends from base 6, and is disposed about a central axis 32; and a plurality of video cameras 34 (four are shown in the illustrated example arranged at 90° angles with respect to adjacent cameras 34) which are each coupled to frame 30 facing outward from central axis 32. The plurality of cameras 34 are disposed generally at the same elevation and positioned so as to capture a continuous 360° view about the central axis, as is described/shown further below in conjunction with FIG. 8. Such feature is provided by arranging the plurality of cameras 34 about central axis 32 such that the field of view FV (FIGS. 4 and 8) of each camera 34 overlaps the field of view FV of an adjacent camera 34. In the illustrated example embodiment, cameras 34, each having a field of view of 120° were employed. As shown in FIG. 8, such arrangement provides for compete 360° coverage, with minimal blind spots BS (shown attached) extending a very short distance d (in the example embodiment is about 4 inches) from base 6, and large overlapping coverage areas OC which begin at the very short distance d from base 6. While such small blind spots BS do not materially affect observation by device 2, it is to be appreciated that such blind spots BS may be reduced/eliminated by using more cameras and/or cameras having a wider field of view.

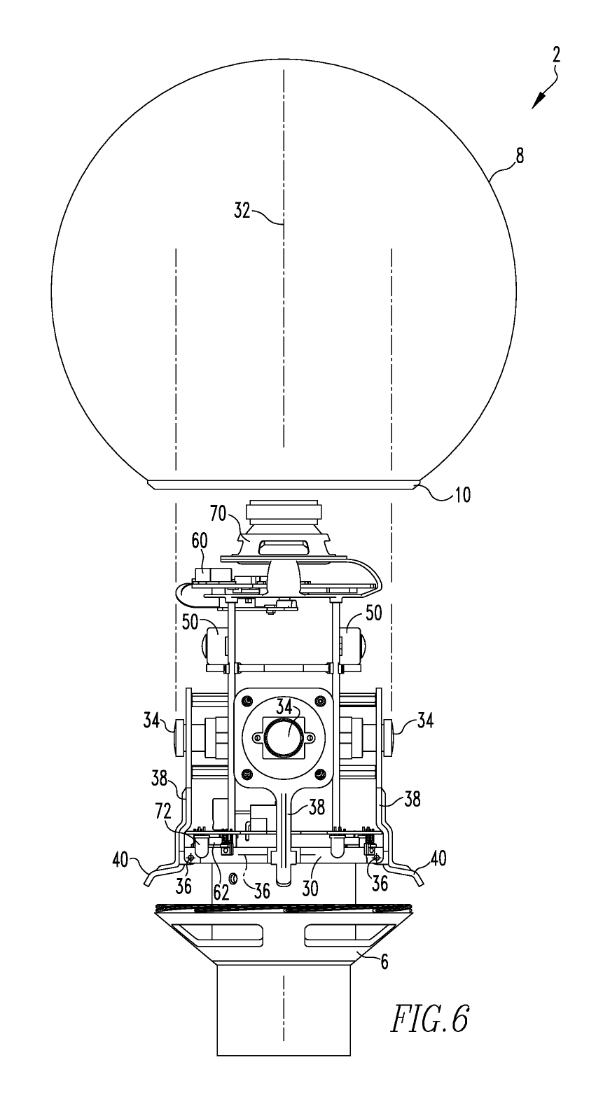

Continuing to refer to FIGS. 2-5, and additionally to FIG. 6, each camera 34 is pivotably coupled to frame 30 so as to be moveable about a respective hinge axis 36. In the illustrated example embodiment, each camera 34 is pivotably coupled to frame 30 via a respective mount 38 such that each camera 34 is movable, as is discussed in further detail below, between a first position, such as shown in FIG. 6, and a second position, in which each camera 34 is further from central axis 32 than the first position, such as shown in FIGS. 2-5. In an example embodiment, each camera 34 is biased in the first position via a biasing mechanism (e.g., a spring or other suitable mechanism). As shown in FIG. 6, when disposed in the first position, each camera 34 (i.e., the face of the lens thereof) is disposed generally parallel to central axis 32. When disposed in the second position, each camera (i.e., the face of the lens thereof) is disposed generally at an angle 4) with respect to the central axis, such as shown in FIG. 4. In order to minimize a blind spot near base structure 4, angle 4, in degrees, is preferably generally equal to (180−field of view FV of the camera 34)/2. In the illustrated example embodiment, wherein the field of view FV of each camera 34 is 120°, angle ϕ is thus (180−120)/2 or 30°.

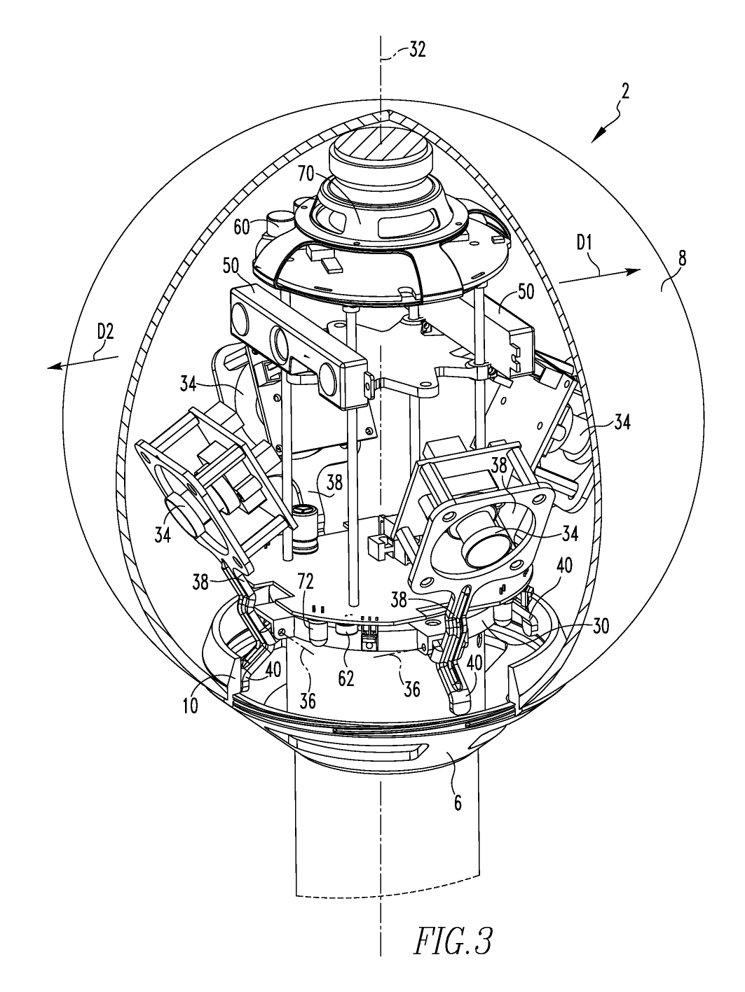

Such movement of cameras 34 from the first positions (such as shown in FIG. 6) to the second positions (such as shown in FIG. 4), is caused by movement of enclosure 8 (and enclosure base 10 thereof) from a positioning not engaged with base 6, such as shown in FIG. 6, to a positioning in which enclosure 8 and enclosure base thereof is engaged with base 6. More particularly, as enclosure 8 is lowered (generally along central axis 32) from a positioning such as shown in FIG. 6 around frame 30 and related components of device 2, enclosure base 10 engages outward extending portions 40 of each respective mounts 38 (e.g., see FIG. 3), causing each mount 38 and camera 34 coupled thereto, to rotate outward into the second position. Such movement of each of cameras 34 provides for device 2 to be generally completely enclosed by a single housing 8, while also providing for each of cameras 34 to be able to see generally straight down, thus minimizing/eliminating any blind spot near base arrangement 4.

In addition to cameras 34, which are generally used for providing 360° surveillance, device 2 may further comprise a number of additional elements which allow for device 2 to function as more than merely a surveillance device. Referring to FIG. 3, device 2 may further include a number of three dimensional video and infrared capturing devices 50 (e.g., without limitation, an Intel® RealSense device) coupled to frame 30, for capturing dimensional data and attributes of objects and persons near device 2. As discussed further below, such data may be used to identify persons/objects in interactions with persons. In the illustrated example embodiment, device 2 includes two three dimensional video and infrared capturing devices 50, a first device 50 which is oriented facing in a first direction D1 outward from central axis 32; and a second device 50 which is oriented facing in a second direction D2 outward from central axis 32, opposite first direction D1. It is to be appreciated, however that the quantity of devices 50 may be varied without varying from the scope of the disclosed concept.

In addition to components for capturing visual data of the surrounding environment and objects/people therein, device 2 may further include components for collecting audible data from the surrounding environment. Accordingly, device 2 may further include a voice recognition device 60 coupled to frame 30 which is structured to receive and recognize/interpret voices from nearby device 2. Device 2 may also include a microphone 62 for recording audio information.

Device 2 may include a variety of other components for sensing and/or interacting with objects/persons nearby. Accordingly, device 2 may further include: a speaker 70 coupled to frame 30, for providing audio communications to persons; a number of LEDs 72 or other visible indicators for providing indications (e.g., status, warnings, etc.) to persons nearby; or any of a variety of other sensors, e.g., without limitation, temperature, humidity, motion, electric current, GPS, etc.

Device 2 may include, or be connected thereto (via wired or wireless connection) one or more processing devices in order to handle/process data received from any of the previously described components of device 2 which may be connected thereto. Such processing devices may comprise, for example, a microprocessor, a microcontroller or some other suitable processing device, and a memory portion that may be internal to the processing portion or operatively coupled to the processing portion and that provides a storage medium for data and software executable by the processing portion for controlling the operation of one or more of the previously described components of processing device 2. The memory portion can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory.

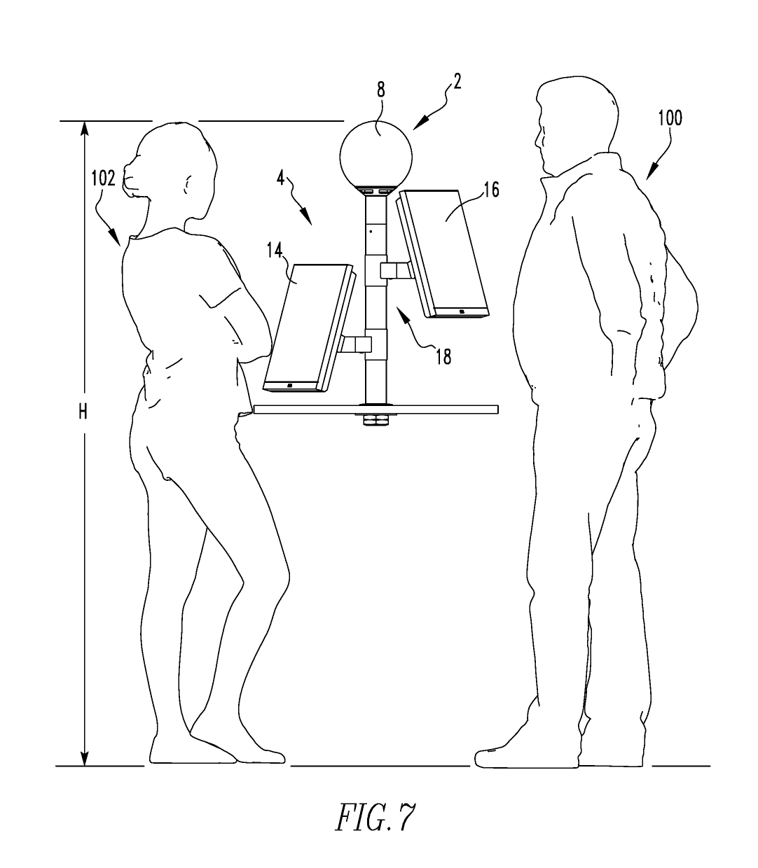

Having thus described the general components of an example device 2, some examples of uses/functionality of device 2 will now be described. Referring to FIGS. 7 and 8, an example arrangement of device 2 is shown in which device 2 is located generally between a customer 100 and a cashier 102 at a height H which is generally at or about the elevation of the faces of customer 100 and cashier 102. Preferably, height H is in the range of about 5 feet to about 7 feet, so as to be located at an elevation similar to that of the faces of the majority of the human population. Device 2 is designed to provide transaction biometric identification—by using video capturing devices 34, 50 and visual recognition software associated therewith to identify transaction (sales, bank etc.) with a unique digital token representing the biometric identity of each of the customer 100 and operator 102 (cashier, teller etc.) and any others present at the time of the transaction. Tokenization is used to replace readable data (e.g., picture of customer's face, picture or data of any form of ID, customer's name) with only a digital stamp which represents unique sequence of numbers and letters generated by biometric identification application. Such digital stamp cannot be converted back into the source data, in this case into a picture of a customer's face. If facial recognition application generates the same token again in regard to a subsequent transaction, we will know that same person was involved in the subsequent transaction, however we will not be able to tell the name of the person or generate their picture based on the token ID. Such arrangement insures customer's privacy.

Device 2 may be used for human identification by capturing an image and visual recognition of the face of customer 100 via video and IR capturing devices 34 and 50 to get additional information about customer 100 (e.g., demographic—such as gender, age, origin etc.). This information can be used for personalized interaction with customer 100. For example, personalized promotions or suggested items based on the approximate age of customer 100, gender, and/or basket analysis can be sent to touch screen monitor 16 facing customer 100. Customer 100 may accept and/or otherwise interact with the promotion by touching touch screen monitor 16.

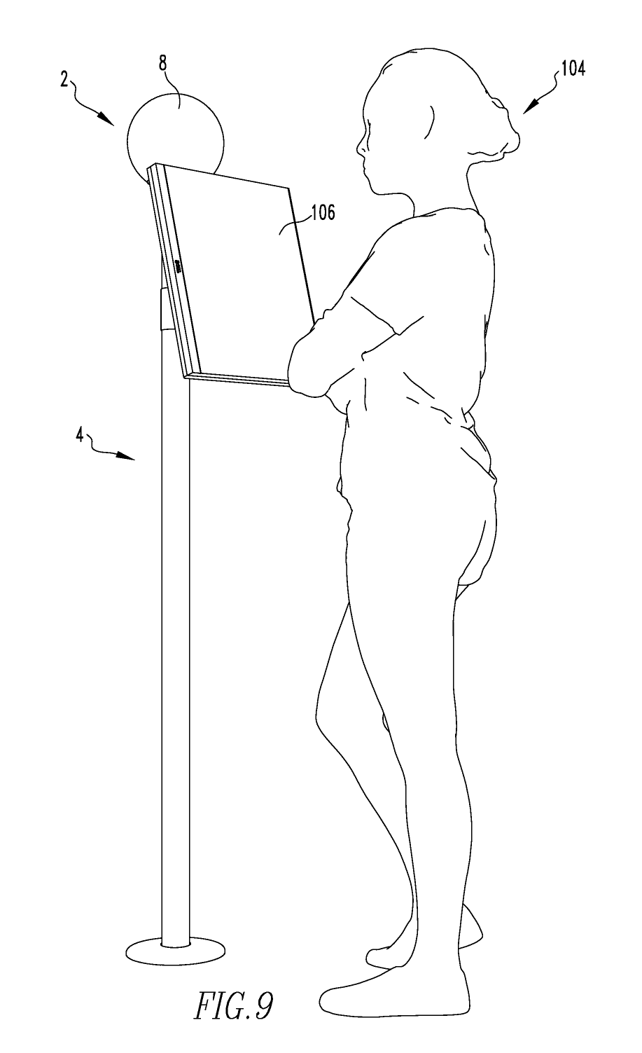

Referring to the arrangement of FIG. 9, device 2 may be used in a visual interaction with a person 104 (customer, shopper, store manager, cashier etc.)—by using a regular and/or touch controlled digital display 106. For example, person 104 enters a clothing store and is scanned by device 2 (demographics, body metrics etc.). Device 2 checks what can be offered (e.g., clothing items, promotions, etc.) to person 104 based on gender, body metrics, age, personal purchase history, preset favorites and filters. Price, brand and category of available items may then be presented on display 106. Such results may be presented using an actual avatar of the body of person 104 to render person 104 wearing offered items. The avatar of person 104 can be readily rendered since device 2 is able to get body metrics of person 104 (such as described immediately below).

Metrics of person 104 may be obtained/determined using video and infrared capturing device 50. Embodiments of device 2 can get complete body metrics of person 104 (accuracy would depend on what person 104 is wearing at the time of the scan as baggy/loose fitting clothing may obscure dimensions) and report immediately what exactly can be offered to person 104 (e.g., what is in store inventory, assortment, style etc.). Device 2, having a generally unobstructed view of the floor thereby (display 106 is mounted so as to not obscure the view by device 2) can scan the foot of person 104 and report items that are available for immediate purchase (i.e., from store inventory) on display 106 or can be ordered online. If person 104 decides to buy a particular offered item, that item, for example, a dress short, there are a few scenarios. One, is that the system now knows person's body metrics and can choose precisely what size dress short needs to be delivered to person 104, or second, see next paragraph.

After scanning the body of person 104, device 2 knows exactly not only body metrics, but also body specifics, e.g., asymmetrical or disproportionate parts of the body. After the person 104 chooses an item, body metrics of person 104 can be sent to clothing production facility's automated system to generate custom patterns and offer to person 104 custom tailored items on demand, without excessive cost of a personal tailor. Another example of an on demand personalized tailoring service is custom designed bras for women. There are many variables involved in the design and production of women's bras, however they all get unified into a few sizes to make production efficient and cost affordable. Such approach makes the process of finding a perfect bra a nightmare for most women. A fast metrics and computerized pattern design system in accordance with embodiments of the concepts disclosed herein would make an on-demand custom tailored bra a reality.

Device 2 provides for voice interaction with a person (customer, shopper, store manager, cashier etc.)—by using one or more microphones (e.g., microphone 62) and one or more speakers (e.g., speaker 70) along with voice recognition and voice generation software, device 2 can interact audibly with a customer (e.g., thank a shopper for the business, offer additional services and individualized touch, for example calling person by name if person prefers).

Device 2 provides for capturing of various data. By using video, IR and audio capturing devices 50; on board sensors of different sorts, including temperature, humidity, motion, electric current, GPS; device 2 may be used to control other devices (HVAC, Refrigeration Units, Lights etc.) to automate equipment service requests. As an example use, yard lights and canopy lights of a convenience store often go out of order and service orders are not created in a timely manner. This affects the store/gas station image and sales and customer experience (e.g., customers do not want to stop at the site because it looks under managed). Solution—installation of an electric current sensor on the electric lines, which is wirelessly connected to device 2. Device 2 will calibrate itself when all lights are working and create service tickets when electric current is lower. As another example, device 2 may generate predictive alerts and warnings pointing to possible equipment malfunction in the near feature due to changes in electric consumption patterns. Equipment malfunctions are hard to predict and preventive maintenance is done based on uniformed schedule suggested by manufacture without consideration of actual environment conditions. This leads to excessive or, vice versa, insufficient maintenance. Solution—electric current changes in consumption of equipment can point to problems about to happen and create preventive maintenance orders. Example: dirty coils cause decline in efficiency and increase in electric consumption by refrigeration equipment and eventually lead to equipment malfunction. By analyzing electrical current, temperature inside and outside of refrigerated area, device 2 generates predictive alerts, warnings and/or creates service requests.

As another example, device 2 and connected systems may be used to provide In-Moment customer experience and enhance in-store offer execution with real-time personalization during non-disruptive sales workflow by utilizing non-invasive, non-identity based personalization technics based on low latency cycles of continuous data capturing, enrichment and analyses of local offers repository based on redundant—asynchronous replication with in-cloud repository.

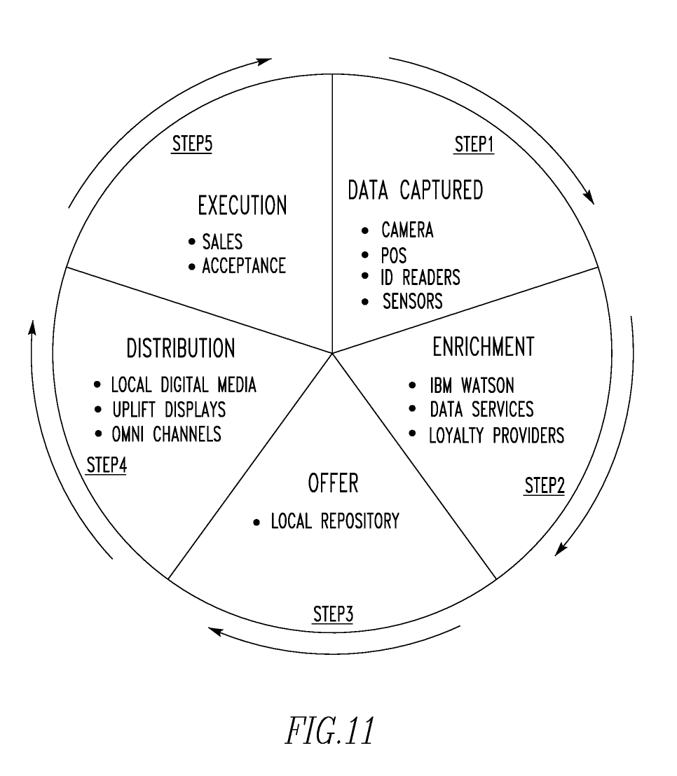

In reference to FIG. 11, as previously discussed, device 2 has different methods of collecting data—when a person appears in range of device 2 visual data is captured (Step 1)—e.g., body metrics, facial recognition, etc. and first low latency cycle of in-moment customer offer personalization begins. Captured data is enriched by other services and/or providers (Step 2). In this use case—video data goes into visual recognition application that analyses captured data to determine maximum number of identifiable attributes with the goal to narrow the number of possible responses by system to human to most effective and relevant. Example of determined attributes (not limited to) by visual recognition application and/or service: gender, age, origin, body metrics, face recognition token or results. Enriched data then is analyzed (Step 3) by offer personalization application that is requesting data or information from local database repository to find most relevant offers within given attributes (parameters). If relevant offer(s) is found, it is distributed (Step 4) to recipient's attention over available means for this recipient (depends on previously collected knowledge about recipient/attribute) distribution channels, such as, but not limited to: local digital media, uplift display, omni channels—social media, Apple wallet coupons, other human interface devices like voice interaction. If recipient confirms interest in proposed offer, it is executed (Step 5). In this case, a shopper accepts suggested merchandise. In any case transaction can continue in closed loop and capture more data. This would be considered as the next low latency cycle. For example, when shopper has approached device 2, he/she uses a Loyalty card (Step 1)—data captured.

Captured data is enriched (Step 2) by Loyalty Provider (Host) with shopper's profile, shopping behavior, price sensitivity and other attributes and/or data which would help to find, again, the offers that are most relevant to the shopper's profile. Device 2 can use other data enrichment services (Step 2) (in the same cycle) to make the most desirable offer at this moment (example: time of the day—coffee in the morning, sandwich at lunch time; local events—football, nearest school event, etc.) or based on given conditions—weather, products life cycle, etc. Additional data is now analyzed by an offer personalization application (Step 3) to choose the most effective and relevant offer corresponding to the attributes received. Same as in previous cycle, Step 4 and Step 5 are repeated and new cycle starts if transaction is not finished and new data captured. Let's say no data is captured and previous two cycles never took place. In this case, absolutely none of the parameters were captured and a customer comes to a point of sale near device 2 with merchandise already picked. The cycle begins because device 2 has just captured data (Step 1) about the merchandise the shopper has chosen. Enriching (Step 2) this information (shopper's basket items, geo location of the transaction, weather, time of the day, etc.) with other information received from other applications/services—in this case, a basket items analytics application—affinities, nutritional information, promotions, offer personalization (Step 3) will look into local repository to find most attractive upsell offer within analyzed parameters. Same as in previous cycle, Step 4 and Step 5 are repeated and new cycle starts if transaction is not finished and new data captured.

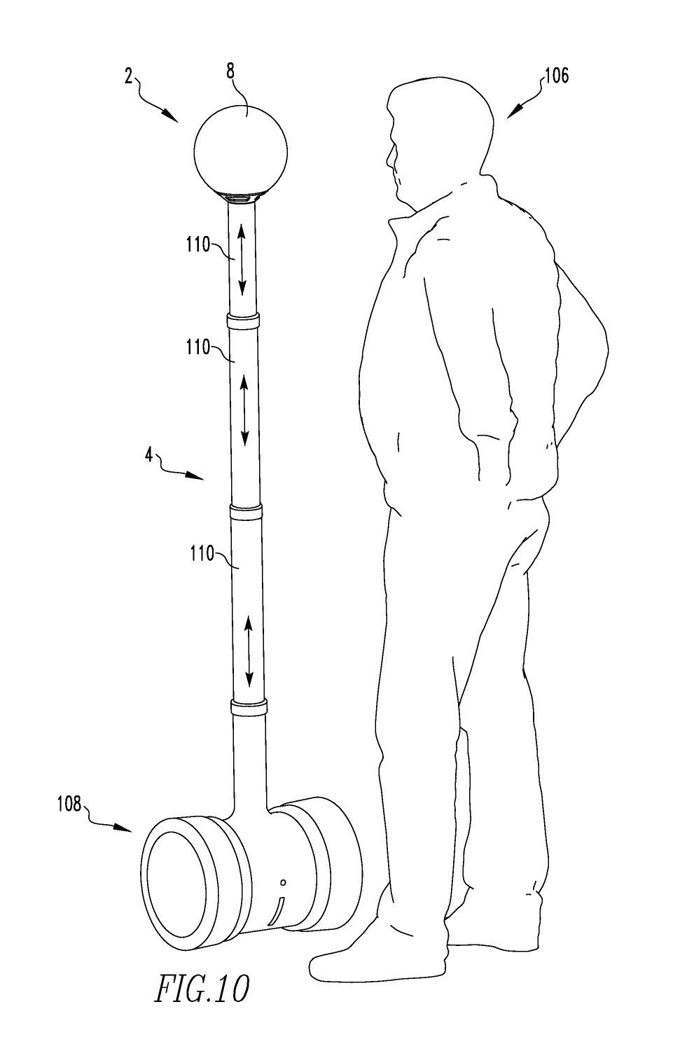

FIG. 10, illustrates an example mobile arrangement in which device 2 may be employed for collecting data and/or acting as a point of interaction between electronic networks/systems and the physical environment. In such embodiment, device 2 is mounted on a base arrangement 4 having a wheeled arrangement 10, which may be controlled via remote or device 2, such that device 2 may be selectively moved about a selected environment. In addition to being mobile, the height at which device 2 is positioned may be selectively adjusted via the number of telescoping portions 110 of base arrangement 4 in order to provide for optimum placement of device 2 relative to objects/persons or interest in the surrounding environment. As an example, device 2 may adjust one or more of telescoping portions 110 so as to place device 2 in an improved and/or optimized position with respect to the face of a person (e.g., person 106) so as to be able to best capture facial data of person 106.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the disclosed concepts have been described in detail for the purpose of illustration based on what is currently considered to be the most practical and preferred embodiments, it is to be understood that such detail is solely for that purpose and that the disclosed concepts are not limited to the disclosed embodiments, but, on the contrary, is intended to cover modifications and equivalent arrangements that are within the spirit and scope of the appended claims. For example, it is to be understood that the disclosed concepts contemplate that, to the extent possible, one or more features of any embodiment can be combined with one or more features of any other embodiment.

What is claimed is:

1. A device for capturing data comprising:
a base,
a frame extending from the base, the frame disposed about a central axis; and
a plurality of video cameras coupled to the frame facing outward from the central axis, wherein the plurality of video cameras are positioned so as to capture a continuous 360° view outward around the central axis.

2. The device of claim 1, wherein the plurality of cameras comprise four cameras, each camera being disposed at a 90° degree angle with respect to each adjacent camera.

3. The device of claim 1, wherein each camera of the plurality of cameras is disposed at the same elevation as the other cameras of the plurality of cameras.

4. The device of claim 1, wherein each camera of the plurality of cameras is pivotably coupled to the frame.

5. The device of claim 1, wherein each camera is pivotably coupled to the frame via a mount, wherein each camera is movable between a first position and a second position, the second position being further from the central axis than the first position.

6. The device of claim 5, wherein when disposed in the first position, each camera of the plurality of cameras is disposed generally parallel to the central axis, and wherein when disposed in the second position, each camera is disposed at an angle with respect to the central axis.

7. The device of claim 6, wherein the angle, in degrees, is generally equal to (180−the field of view of the camera)/2.

8. The device of claim 6, wherein each camera of the plurality of cameras is biased in the first position via a biasing mechanism.

9. The device of claim 8, further comprising an enclosure having an enclosure base,
wherein the enclosure is structured to enclose the plurality of cameras,
wherein the enclosure is selectively coupleable to the base via the enclosure base, and
wherein each camera of the plurality of cameras is movable from the first position to the second position via an engagement between the enclosure base and the mount to which each camera is pivotally coupled to the frame as the enclosure base is moved toward the base generally along the central axis.

10. The device of claim 9, wherein the enclosure base is selectively coupleable to the base via a threaded engagement.

11. The device of claim 9, wherein the enclosure is of a generally spherical shape.

12. The device of claim 11, wherein the enclosure is formed as a unitary piece of material.

13. The device of claim 12, wherein the material comprises acrylic.

14. The device of claim 1, further comprising a number of three dimensional video and infrared capturing devices coupled to the frame.

15. The device of claim 14, wherein the number of three dimensional video and infrared capturing devices comprises:
a first three dimensional video and infrared capturing device oriented in a first direction facing outward from the central axis; and
a second three dimensional video and infrared capturing device oriented facing in a second direction, opposite the first direction, outward from the central axis.

16. The device of claim 1, further comprising a voice recognition device coupled to the frame.

17. The device of claim 1, further comprising a speaker coupled to the frame.

18. The device of claim 1, further comprising one or more of: an indication light, a microphone, and/or an environmental sensor coupled to the frame.

19. An arrangement for capturing data related to a transaction, the arrangement comprising:
a first area structured to receive a first party involved in the transaction;
a second area structured to receive a second party involved in the transaction; and
a device as recited in claim 1 positioned generally between the parties at an elevation at an elevation generally at or below the face of at least one of the first or second party.

20. A method of capturing data in a space defined by at least a floor and a number of walls, the method comprising:
positioning a device as recited in claim 1 in the space at a location away from the number of walls, the device being supported by a structure extending from the floor of the space; and
capturing data using the device.
